(19) United States
(12) Patent Application Publication
(10) Pub. No.: US 2005/0102312 A1
(43) Pub. Date: May 12, 2005

(54) Information management method

(76) Inventors: Tetsuharu Ohya, Fujisawa (JP); Shingo Ikki, Fujisawa (JP); Kazuyuki Nishikawa, Hadano (JP); Minoru Kobayashi, Hadano (JP); Shinichi Ohtake, Odawara (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/815,705

(22) Filed: Apr. 2, 2004

(30) Foreign Application Priority Data
Nov. 12, 2003 (JP) 2003-382589

(51) Int. Cl. G06F 17/00

(52) U.S. Cl. 707/102

(57) ABSTRACT

An information processing apparatus includes a management master extraction unit which extracts management master information from a management target file; a storage device which stores a file management database in which the management master information on each management target file is registered; a storage event output unit which outputs a signal indicating a storage event of the file; a deletion target extraction unit which extracts information on a management target file corresponding to a deletion request from the file management database; a file deletion unit which deletes the management target file from the storage device based on the information; a management master information update unit which updates validity information on the deleted file in the management master information in the file management database into invalid; and a deletion information output unit which outputs a signal indicating the deletion of the management target file.

### BACKGROUND OF THE INVENTION

The present invention relates to a method for managing information to be deleted (secret information, etc.) which is recorded in information processing apparatuss of individuals or organizations such as companies, and in particular, to techniques for executing the deletion of information which has already been used by trustees (persons/companies commissioned by a truster (commissioning person/company) to do some business operations) in the so-called outsourcing. The “secret information” in this application includes so-called personal information and confidential information.

More and more companies are outsourcing their business operations in order to improve the efficiency of business. Meanwhile, the need for establishing the protection of personal information and secret or classified information is also being recognized and emphasized. In such circumstances, various methods for deleting all the personal information and classified information from a storage device (HDD (Hard Disk Drive), etc. storing the information) after the information is properly used are being proposed.

For example, in order to provide a method and device consistently capable of deleting information stored in magnetic disks perfectly and instantly with ease when the magnetic disks are discarded, various methods for deleting information from a magnetic disk of an HDD by aligning magnetization vectors of the disk in the same direction by applying a DC magnetic field in a direction parallel to the disk surface have been proposed. Among such methods, JP-A-2002-163801 proposes an information deletion method for deleting information from the magnetic disk by moving the disk in the same direction as the DC magnetic field being applied in parallel to the disk surface.

### SUMMARY OF THE INVENTION

However, in conventional information deletion techniques, deletion of information remaining in magnetic disks or magnetic storage devices of the trustees in the outsourcing of business operations or tasks has not been taken into consideration at all.

In the case of outsourcing business operations or tasks, information concerning the business operations or tasks is handed over or transferred from the truster to the trustee. The transfer of the information may include communication of the information via a network, delivery of a record medium storing the information, inputting information printed on paper etc. to a system of the trustee, etc. By use of the transferred information, processes according to a request by the truster are carried out in the system of the trustee. However, even when the trustee has completed the processes or does not have to continue the processes (termination of a contract between the truster and the trustee, etc.), the information still remains in the system of the trustee. The information may be classified information or personal information that the truster hopes to conceal from third parties, that is, information that the truster intends to delete if it is unnecessary.

However, conventional techniques only specify methods for simply deleting information, while methods for efficiently deleting information remaining in the system of the trustee in cases of the outsourcing have not been disclosed. Especially, there has been disclosed no method for deleting information on a particular one of trusters (whose contract has ended, for example) from the system of the trustee. This fact becomes more clear by considering conventional information deletion methods which will be described below.

In conventional information deletion methods, the so-called “whitening” is mainly employed, in which a prescribed 0/1 data pattern is written across all the sectors of the storage device (HDD, etc.) for a preset number of times (e.g. three times or more). Such methods are capable of deleting all the data stored in a storage device such as an HDD; however, there has been proposed no technique for perfectly deleting a particular file, and as a matter of course, no consideration has been given to a method for perfectly deleting backup files containing personal information and classified information acquired during the business (outsourcing, etc.).

Meanwhile, information management methods already exist in conventional document management systems, etc., from the viewpoints of using information for creating and updating document files. However, such methods have not considered information deletion on the physical level (physically and totally deleting information or a file stored in a storage device such as an HDD), and thus information once deleted can be restored easily by use of a data recovery application, etc.

It is therefore the primary object of the present invention to provide an information processing apparatus, an information management method, a program and a record medium capable of supporting information management efficiently realizing the management of any particular information.

In accordance with the present invention for attaining the object, the secret information is deleted, the result of the deletion is detected, and the owner of the information is informed of the result of the deletion. Specific aspects of the invention are as follows:

In accordance with an aspect of the present invention, there is provided an information processing apparatus supporting secret information management, comprising: a management master extraction module which receives a management target file containing secret information via an input interface and extracts management master information, including a file ID and information on validity of the management target file, from the management target file; a storage device which stores a file management database in which the management master information on each management target file is registered; a storage event output module which outputs a signal indicating a storage event of the management target file in the storage device to an output interface; a deletion target extraction module which receives a deletion request regarding the management target file via the input interface and extracts information on the management target file corresponding to the deletion request from the file management database; a file deletion module which executes the deletion of the management target file from the storage device based on the information on the management target file extracted by the deletion target extraction module; a management master information update module which updates the validity information on the management target file deleted by the file deletion module, included in the management master information registered with the file management database, into invalid; and a deletion information output module which outputs a signal indicating that the management target file has been deleted by the file deletion module to the output interface.

In accordance with another aspect of the present invention, there is provided an information management method for managing secret information by use of an information processing apparatus, comprising the steps of: receiving a management target file containing secret information via an input interface and extracting management master information, including a file ID, information on access authority to the management target file, and information on validity of the management target file, from the management target file; registering the management master information on each management target file in a file management database; storing the management target file in a storage device associating the same with the management master information; outputting a signal indicating the storage event of the management target file in the storage device to an output interface; receiving a deletion request regarding the management target file via the input interface and extracting information on the management target file corresponding to the deletion request from the file management database; executing the deletion of the management target file from the storage device based on the information on the management target file extracted from the file management database; updating the validity information on the management target file deleted from the storage device, included in the management master information registered with the file management database, into invalid; and outputting a signal indicating that the management target file has been deleted to the output interface.

In accordance with another aspect of the present invention, there is provided a program for instructing an information processing apparatus to execute a secret information management method comprising the steps of: receiving a management target file containing secret information via an input interface and extracting management master information, including a file ID, information on access authority to the management target file, and information on validity of the management target file, from the management target file; registering the management master information on each management target file in a file management database; storing the management target file in a storage device associating the same with the management master information; outputting a signal indicating the storage event of the management target file in the storage device to an output interface; receiving a deletion request regarding the management target file via the input interface and extracting information on the management target file corresponding to the deletion request from the file management database; executing the deletion of the management target file from the storage device based on the information on the management target file extracted from the file management database; updating the validity information on the management target file deleted from the storage device, included in the management master information registered with the file management database, into invalid; and outputting a signal indicating that the management target file has been deleted to the output interface. The secret information management program is composed of codes for executing the operations of the above steps. The present invention also relates to a computer-readable record medium storing the program.

### BRIEF DESCRIPTION OF THE DRAWINGS

The other objects and features of the present invention will become more apparent from the consideration of the following detailed description taken in conjunction with the accompanying drawings, in which:

FIG. 1 is a block diagram showing the structure of a network including an information processing apparatus in accordance with an embodiment of the present invention;

FIG. 2A is a table showing an example of data structure of a file information management master database employed in the embodiment;

FIG. 2B is a table showing an example of data structure of a trustee information management master database employed in the embodiment;

FIG. 3 is a block diagram showing an example of a business model that is applicable to the embodiment;

FIG. 4 is a flow chart showing a file registration process in a classified information management method of the embodiment;

FIG. 5 is a flow chart showing a file reference process in the classified information management method of the embodiment;

FIG. 6 is a flow chart showing a file backup process in the classified information management method of the embodiment;

FIG. 7 is a flow chart showing a file update process in the classified information management method of the embodiment;

FIG. 8 is a flow chart showing a file deletion process in the classified information management method of the embodiment; and

FIG. 9 is a conceptual drawing showing the details of the file deletion process in the classified information management method of the embodiment.

### DETAILED DESCRIPTION OF THE EMBODIMENTS

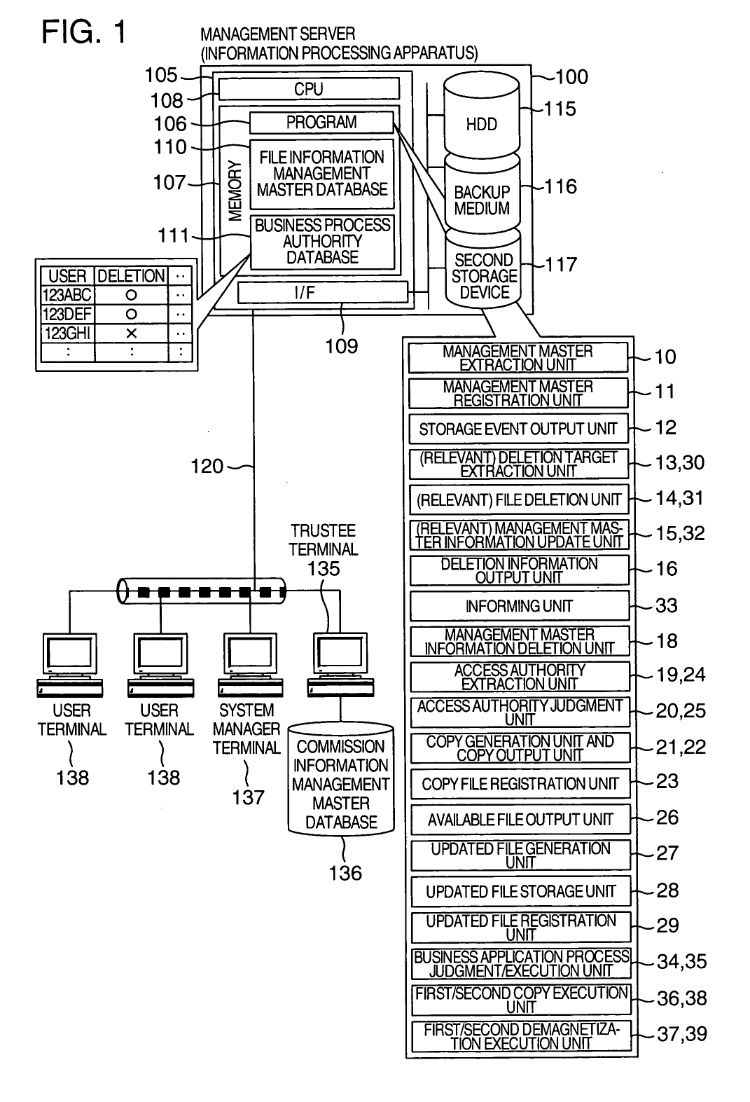

Referring now to the drawings, description will be given in detail of embodiments in accordance with the present invention. FIG. 1 is a block diagram showing the structure of a network including an information processing apparatus 100 in accordance with an embodiment of the present invention. A management server 100 as the information processing apparatus 100 of this embodiment (hereinafter referred to as a “server 100”) stores a program 106 (for implementing the functions of the information processing apparatus of the present invention) in its memory 107 and reads and executes the program 106 by its CPU (Central Processing Unit) 108. The program 106, a file information management master database 110, and a business process authority database 111 are usually stored in an HDD 115, and are expanded and loaded in the memory 107 when the process is executed.

The memory 107 also stores the file information management master database 110 and the business process authority database 111. The file information management master database 110 manages attribute information on files as the targets of the classified information management. In the business process authority database 111, the presence/absence of deletion authority, backup authority and/or usage authority of each user regarding a “management target file” (file as a target of management) during the execution of a business application using the management target file is stipulated.

The server 100 also includes an I/O interface 109 for communicating data with external devices via a network 120 (LAN, Internet, etc.) and inputting/outputting data, the HDD 115 for storing the management target files, a backup medium 116 for storing copied data of the management target files, and a second storage device 117 to be used for processes for deleting the management target files and files derived from the management target files (copy files, updated files, etc.).

The backup medium 116 may be a record medium of any type (storing information electrically, magnetically, optically, etc.). Examples of the backup medium 116 include a magnetic tape, an optical disk, a magneto-optic disk, a flexible disk and an HDD. The second storage device 117 can be implemented by an HDD, for example.

The aforementioned program 106 includes functional blocks which will be described below. First, the program 106 includes a management master extraction unit (module) 10 which receives a management target file containing secret information via the I/O interface 109 (input interface) and extracts management master information (including a file ID and information on the validity of the management target file) from the management target file. The program 106 may also include a management master registration unit 11 which registers the management master information of each management target file with the file information management master database 110 (file management database).

A storage event output unit 12 outputs a signal indicating a storage event (storing the management target file in the HDD 115 (storage device)) to the I/O interface 109 (output interface). A deletion target extraction unit 13 receives a deletion request (requesting deletion of a management target file) through the I/O interface 109 (input interface) and extracts information on the management target file corresponding to the deletion request from the file information management master database 110.

A file deletion unit 14 executes the deletion of the management target file from the HDD 115 based on the information on the management target file extracted by the deletion target extraction unit 13. A management master information update unit 15 updates the validity information on the management target file (deleted by the file deletion unit 14), included in the management master information which has been registered with the file information management master database 110, into “invalid”. A deletion information output unit 16 outputs a signal indicating that the management target file has been deleted by the file deletion unit 14 to the I/O interface 109 (output interface).

A management master information deletion unit 18 locates the management master information on the management target file stored in the file information management master database 110 and deletes the management master information if “deletion mode information” contained in the deletion request designates a deletion mode that requests deletion of the management master information in addition to the deletion of the management target file.

An access authority extraction unit 19 receives a backup request (requesting backup of a management target file) via the I/O interface 109 (input interface) and extracts access authority information on the management target file corresponding to the backup request from the file information management master database 110. An access authority judgment unit 20 receives user authority information on the user corresponding to the backup request via the I/O interface 109 (input interface) and judges whether the management target file corresponding to the backup request may be accessed or not by checking the user authority information with the access authority information.

A copy generation unit 21 extracts the management target file corresponding to the backup request from the HDD 115 and generates a copy file of the management target file if the access authority judgment unit 20 judged that the management target file may be accessed. A copy output unit 22 outputs the copy file of the management target file to the backup medium 116. A copy file registration unit 23 extracts management master information on the copy file and stores the extracted management master information in the file information management master database 110.

An access authority extraction unit 24 receives a usage request (requesting usage of a management target file) via the I/O interface 109 (input interface) and extracts access authority information on the management target file corresponding to the usage request from the file information management master database 110. An access authority judgment unit 25 receives user authority information on the user corresponding to the usage request via the I/O interface 109 (input interface) and judges whether the management target file corresponding to the usage request may be accessed or not by checking the user authority information with the access authority information.

An available file output unit 26 extracts the management target file corresponding to the usage request from the HDD 115 and outputs the extracted management target file to the I/O interface 109 (output interface) if the access authority judgment unit 25 judged that the management target file may be accessed. An updated file generation unit 27 receives an update process (for updating the management target file outputted by the available file output unit 26) via the I/O interface 109 (input interface) and thereby generates an updated file.

An updated file storage unit 28 stores the updated file in the HDD 115. An updated file registration unit 29 extracts management master information on the updated file and stores the extracted management master information in the file information management master database 110.

A relevant deletion target extraction unit 30 extracts information on the copy file or the updated file (derived from the management target file corresponding to the deletion request) in addition to the information on the management target file from the file information management master database 110. A relevant file deletion unit 31 executes the deletion of the copy file or the updated file from the backup medium 116 or the HDD 115 based on the information on the copy file or the updated file extracted by the relevant deletion target extraction unit 30.

A relevant management master information update unit 32 updates the validity information on the copy file or the updated file (deleted by the relevant file deletion unit 31), included in the management master information which has been registered with the file information management master database 110, into “invalid”. An informing unit 33 informs a second information processing apparatus (which is connected with the information processing apparatus via a network) that the copy file or the updated file has been deleted by the relevant file deletion unit 31, via the I/O interface 109 (output interface).

A business application process judgment unit 34 which judges whether a user has the authority or not in the business process authority database 111 (in which the presence/absence of the deletion authority, the backup authority and/or the usage authority of each user regarding each management target file is stipulated) when a business application using a management target file is executed. A business application process execution unit 35 extracts the management target file (to be processed by the business application) from the HDD 115 and provides the management target file to the business application if the business application process judgment unit 34 judged that the user has the deletion authority, the backup authority or the usage authority regarding the management target file.

A first copy execution unit 36 copies all the information stored in the HDD 115 or the backup medium 116 into the second storage device 117 after the deletion of the management target file, the copy file or the updated file from the HDD 115 or the backup medium 116 is executed by the file deletion unit 14 or the relevant file deletion unit 31. A first demagnetization execution unit 37 writes a prescribed data pattern to each memory unit (sector, etc.) of the HDD 115 or the backup medium 116 for a preset number of times.

A second copy execution unit 38 copies all the information stored in the second storage device 117 back into the HDD 115 or the backup medium 116. A second demagnetization execution unit 39 writes a prescribed data pattern to each memory unit (sector, etc.) of the second storage device 117 for a preset number of times.

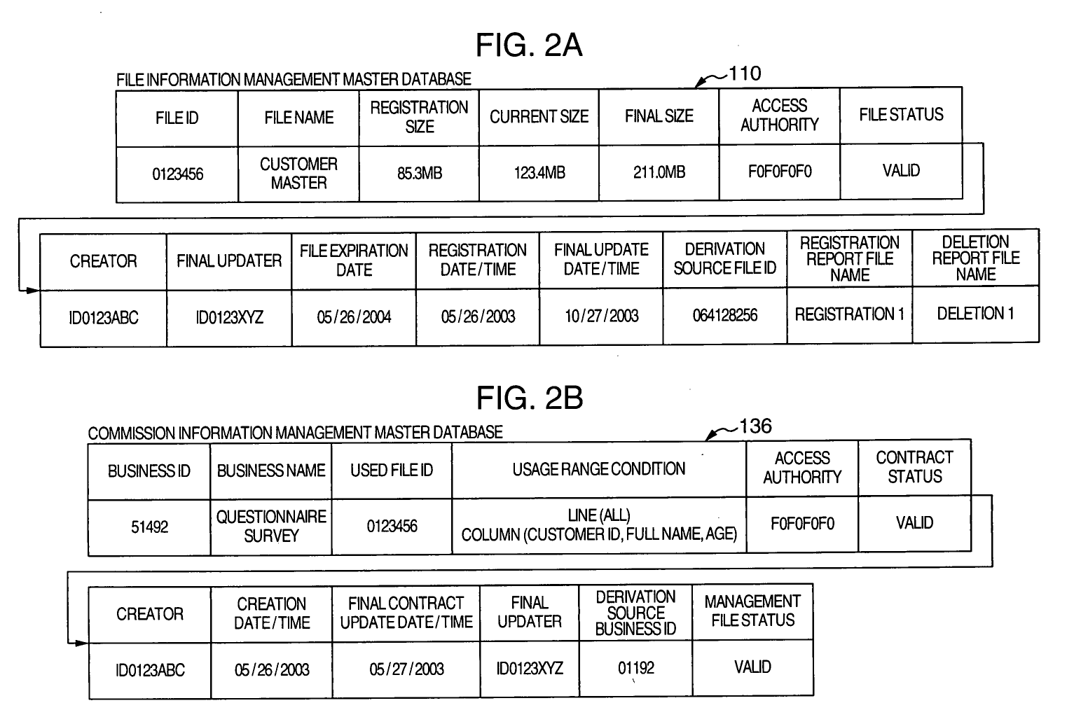

In the following, data structure of the file information management master database 110 and a commission information management master database 136 will be explained. FIG. 2A is a table showing an example of the data structure of the file information management master database 110 of this embodiment, and FIG. 2B is a table showing an example of the data structure of the commission information management master database 136 of this embodiment.

The file information management master database 110 includes a plurality of records associated with one another regarding each management target file. The records regarding each management target file include: file ID of the management target file as a key; file name; registration size (size of the management target file when it was registered); current size; final size; access authority; file status; creator (of the file); final updater; file expiration date (preset by the truster of the management target file, for example); registration date/time; final update date/time; derivation source file ID (file ID of a parent management target file (derivation source file) in cases where the management target file is a copy file or an updated file derived from the parent management target file); registration report file name. (the name of a registration report which is sent to the truster when the management target file is registered with the file information management master database 110); deletion report file name (the name of a deletion report which is sent to the truster when the management target file is deleted from the file information management master database 110 or the HDD 115); etc.

The commission information management master database 136 is a database provided to a trustee terminal 135. The trustee terminal 135 is a terminal of a trustee (commissioned by the truster to do commissioned business operations) who collectively manages the management target files for each of the commissioned business operations. In addition to the trustee terminal 135, terminals such as a system manager terminal 137 for the management of the system including the server 100 and user terminals 138 for staff members of the trustee for carrying out business processes according to the commissioned business operations are connected to the server 100 via the network 120.

The commission information management master database 136 includes a plurality of records associated with one another regarding each business operation. The records regarding each business operation include: business ID (ID assigned to each commissioned business operation received by the trustee terminal 135) as a key; business name; used file ID (generally, a plurality of file IDs of the management target files used for the business operation); usage range condition (permitted usage range in each management target file); access authority; contract status; creator (of the file); creation date/time; final contract update date/time (concerning the contract for the commissioned business operation); final updater; derivation source business ID; management file status; etc.

Other than the above example in which the server 100 is used by the trustee terminal 135, the system manager terminal 137, the user terminals 138, etc. via the network 120, it is also possible to build up the server 100 integrally with one or more of the terminals. In such cases, the server 100 serves also as an information processing apparatus having the functions of the trustee terminal 135 and the user terminal 138. Similarly, while the file information management master database 110, the business process authority database 111 and the commission information management master database 136 are placed in separate devices on the network 120 to be used by the server 100 in the above example, the databases may also be installed in one storage device.

The type of the network 120 connecting the server 100, the trustee terminal 135, the system manager terminal 137, the user terminals 138, etc. is not limited to a LAN or the Internet. Various networks such as a leased circuit, a private circuit, a WAN (Wide Area Network), a power line network, a wireless network, a public circuit network and a cellular phone network can be employed for the network 120. Network techniques such as VPN (Virtual Private Network) are suitable for establishing connections of increased security when the Internet is employed for the network 120.

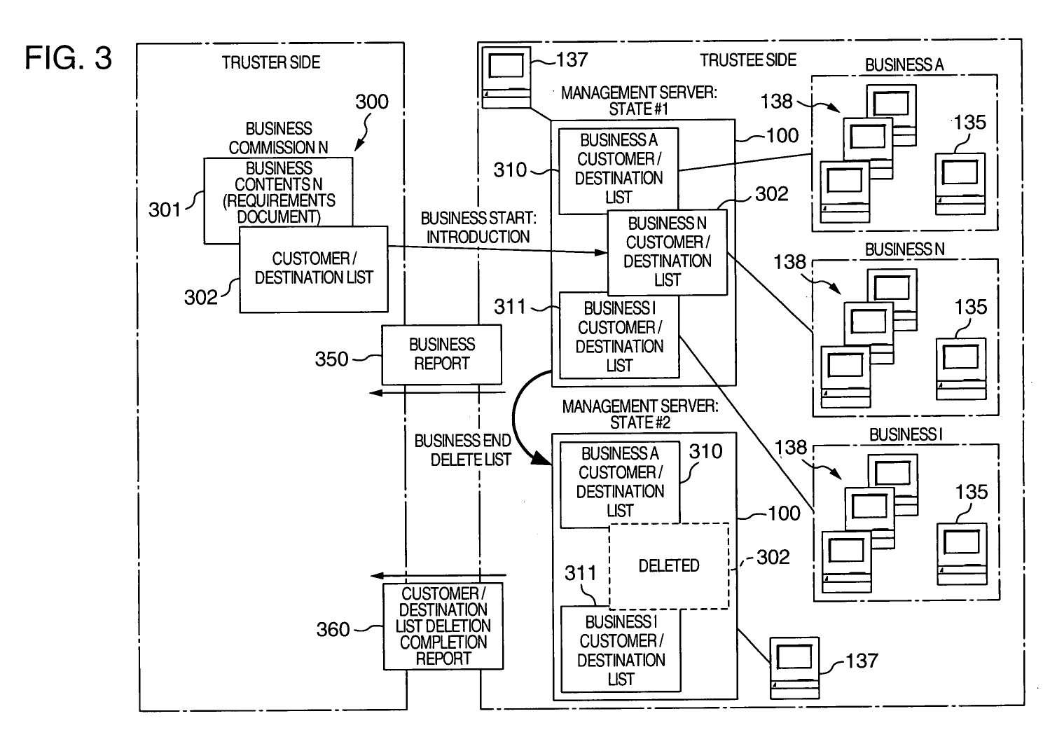

In the following, an example of a business model to which the classified information management method of the present invention can be applied will be explained. FIG. 3 shows an example of a business model that is applicable to this embodiment. The example of FIG. 3 can be divided into two sides: a truster side (truster commissioning a certain business operation) and a trustee side (trustee commissioned by the truster to carry out the business operation).

The truster gives a business commission N to the trustee. The business commission N is an electronic file 300 which is stored in the server 100 via the trustee terminal 135 of the trustee. The electronic file 300 includes a requirements document 301 specifying requirements and contents of the commission and management target files 302 containing classified information such as personal information. For example, when the contents of the business commission N is to transmit e-mails for sales promotion according to a customer list, the management target file 302 includes the customer list containing information on destinations of the e-mails. Such information as the customer list is a “management target” in the classified information management method of the present invention.

The server 100 has accepted the registration of the electronic file 300 from the trustee terminal 135, by which the server 100 has stored the electronic file 300 in the HDD 115 while registering the customer list with the file information management master database 110 as a management target file 302 (MANAGEMENT SERVER: STATE #1). The trustee in this example has undertaken not only the business operation N but also business operations A and I.

The staff of the trustee in charge of the business operation N (corresponding to the business commission N) utilizes the information of the customer list stored in the server 100 by use of the user terminal 138 and thereby carries out the commissioned business operation. Incidentally, the management target files 302 are managed by the trustee terminal 135 for each commissioned business operation.

When the business operation N is completed or when the contract is ended, a business report 350 is sent to the truster (by the server 100 or the trustee terminal 135). The business report 350 may either be an electronic document or a printed document. When the business report 350 is an electronic document, the business report 350 is transmitted to the system of the truster via a network. The business report 350 may also be send by use of a facsimile. Further, the electronic file of the customer list (as the management target file 302) is totally deleted from the HDD 115 (MANAGEMENT SERVER: STATE #2). Information on the deletion of the management target file 302 is transmitted to the truster as a deletion completion report 360, for example.

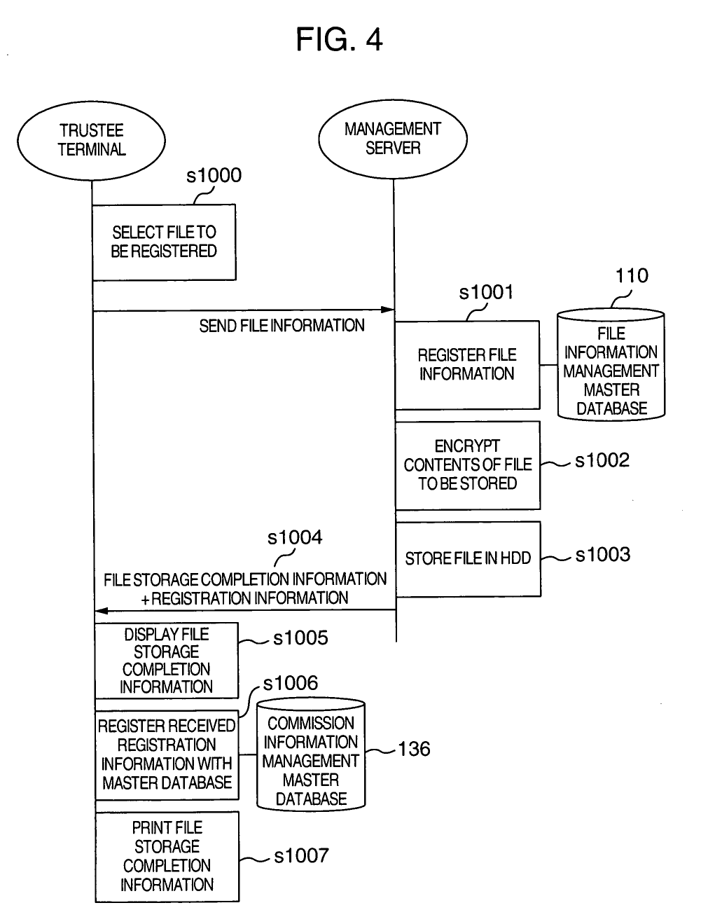

In the following, actual processes of the classified information management method of this embodiment will be described. The following operations corresponding to the classified information management method are implemented by the program 106 which is loaded on the memory 107 of the server 100 (information processing apparatus). The program 106 includes codes for executing various operations which will be explained below. FIG. 4 is a flow chart showing a file registration process in the classified information management method of this embodiment.

When a management target file to be registered is selected by the trustee terminal 135 (S1000), the server 100 receives the selected management target file from the trustee terminal 135, extracts the management master information (including at least the file ID, access authority to the management target file, and the validity information on the management target file) from the management target file, and registers the management master information with the file information management master database 110 (S1001). The management target file is encrypted by means of a prescribed encryption method (encryption key, etc.) (S1002) and stored in the HDD 115 (S1003).

File storage completion information (indicating the storage event of the management target file in the HDD 115) is sent to the trustee terminal 135 (S1004). The trustee terminal 135 displays the file storage completion information on an output interface such as a display (S1005) while registering “registration information” on the management target file in the commission information management master database 136 based on the file storage completion information (S1006). The file storage completion information (indicating the completion of the storage of the management target file) is printed out (S1007). By the above process, the management target file which the trustee terminal 135 received from the truster is registered with the server 100.

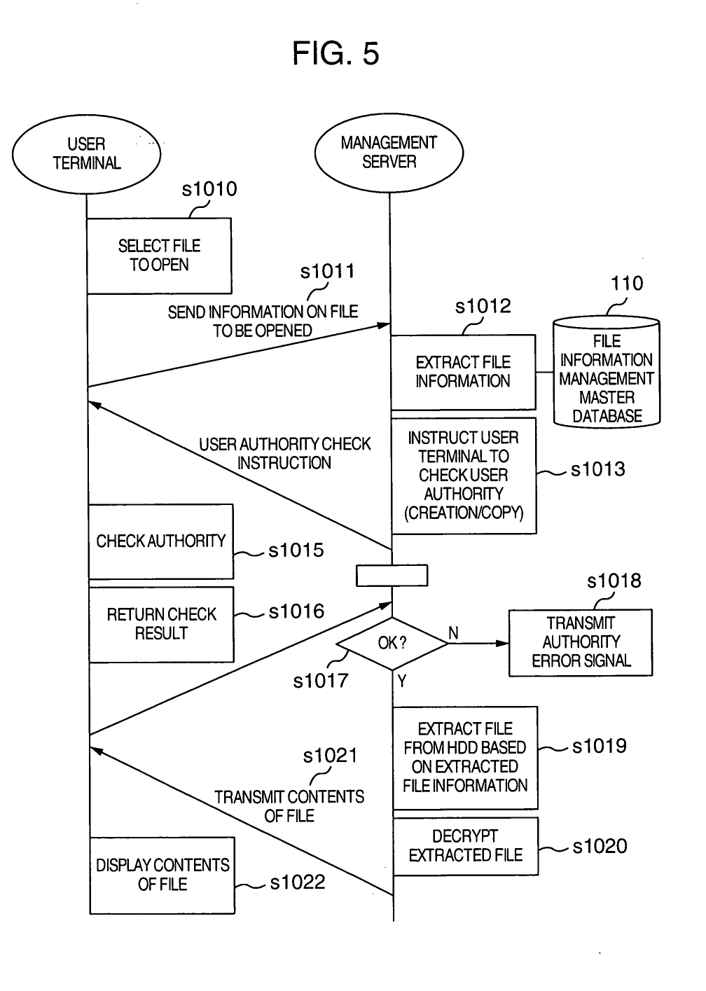

There are cases where a management target file which has been registered with the server 100 is referred to and used by a user terminal 138. FIG. 5 is a flow chart showing a file reference process in the classified information management method of this embodiment. In these cases, a management target file to be referred to is selected by the user terminal 138 (S1010) and a usage request (containing information on the selection event) is transmitted to the server 100 (S1011).

The server 100 receives the usage request and extracts information on a management target file corresponding to the usage request supplied from the file information management master database 110 (S1012). The extracted information includes information on access authority which has been associated with the management target file. Meanwhile, the server 100 instructs the user terminal 138 to check the user authority (S1013). The user terminal 138 executes the user authority check (S1015) and returns the result to the server 100 (S1016). Incidentally, it is also possible to let the user terminal 138 receive the user authority of the user corresponding to the usage request and let the server 100 check the user authority with the access authority and thereby judge whether the management target file corresponding to the usage request may be accessed or not.

The server 100 receives the check result and if the user authority does not match the access authority (S1017: N), outputs an authority error signal to the user terminal 138 (S1018). If the user authority matches the access authority (S1017: Y), the server 100 extracts the management target file corresponding to the usage request from the HDD 115 (S1019), decrypts the extracted management target file (S1020), and transmits the management target file to the user terminal 138 (S1021). The user terminal 138 receives the management target file and displays the received management target file (S1022).

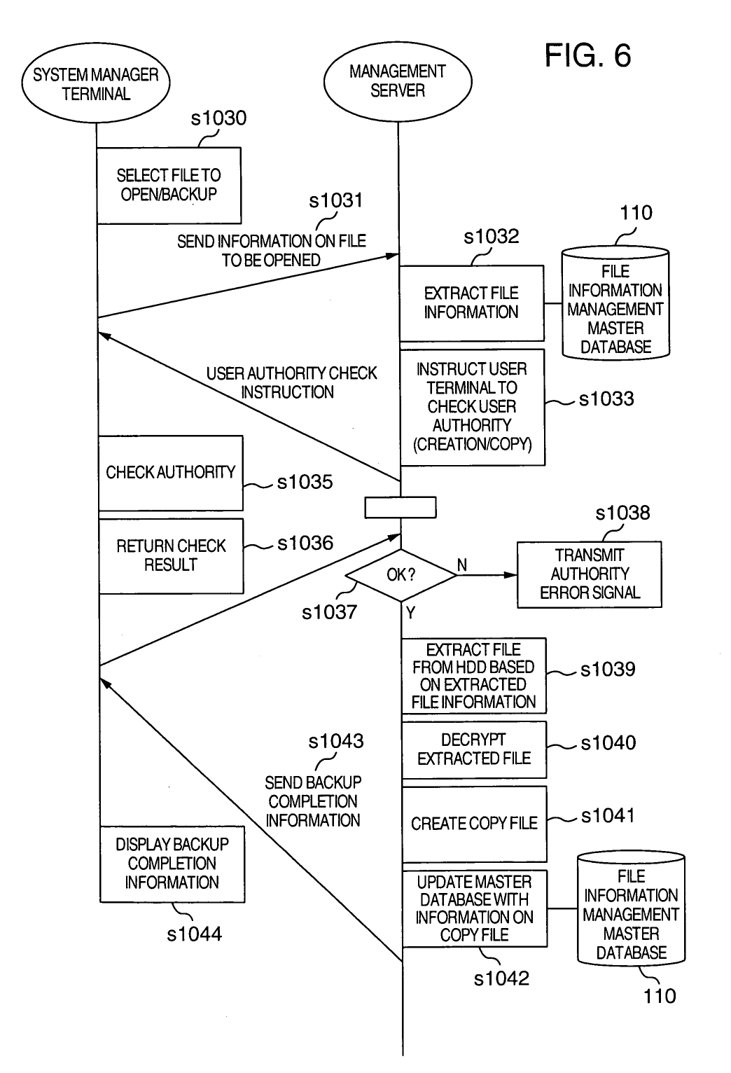

FIG. 6 is a flow chart showing a file backup process in the classified information management method of this embodiment. There are cases where a management target file registered with the server 100 is backed up. In these cases, a management target file to be backed up is selected by the system manager terminal 137 for example (S1030) and a backup request (containing information on the selection event) is transmitted to the server 100 (S1031).

The server 100 receives the backup request and extracts information on a management target file corresponding to the backup request from the file information management master database 110 (S1032). The extracted information includes information on access authority which has been associated with the management target file. Meanwhile, the server 100 instructs the system manager terminal 137 to check the user authority (S1033). The system manager terminal 137 executes the user authority check (S1035) and returns the result to the server 100 (S1036). Incidentally, it is also possible to let the system manager terminal 137 receive the user authority of the manager (system administrator, etc.) corresponding to the backup request and let the server 100 check the user authority with the access authority and thereby judge whether the management target file corresponding to the backup request may be backed up (accessed) or not.

The server 100 receives the check result and if the user authority does not match the access authority (S1037: N), sends an authority error signal to the system manager terminal 137 (S1038). If the user authority matches the access authority (S1037: Y), the server 100 extracts the management target file corresponding to the backup request from the HDD 115 (S1039), decrypts the extracted management target file (S1040), creates a copy file of the management target file (S1041), and outputs the copy file to the backup medium 116.

Subsequently, the server 100 extracts the management master information on the copy file and executes an update process regarding the file in the file information management master database 110 (S1042). Backup completion information (indicating the backup of the management target file has been completed) is sent to the system manager terminal 137 (S1043). The system manager terminal 137 receives and displays the backup completion information (S1044).

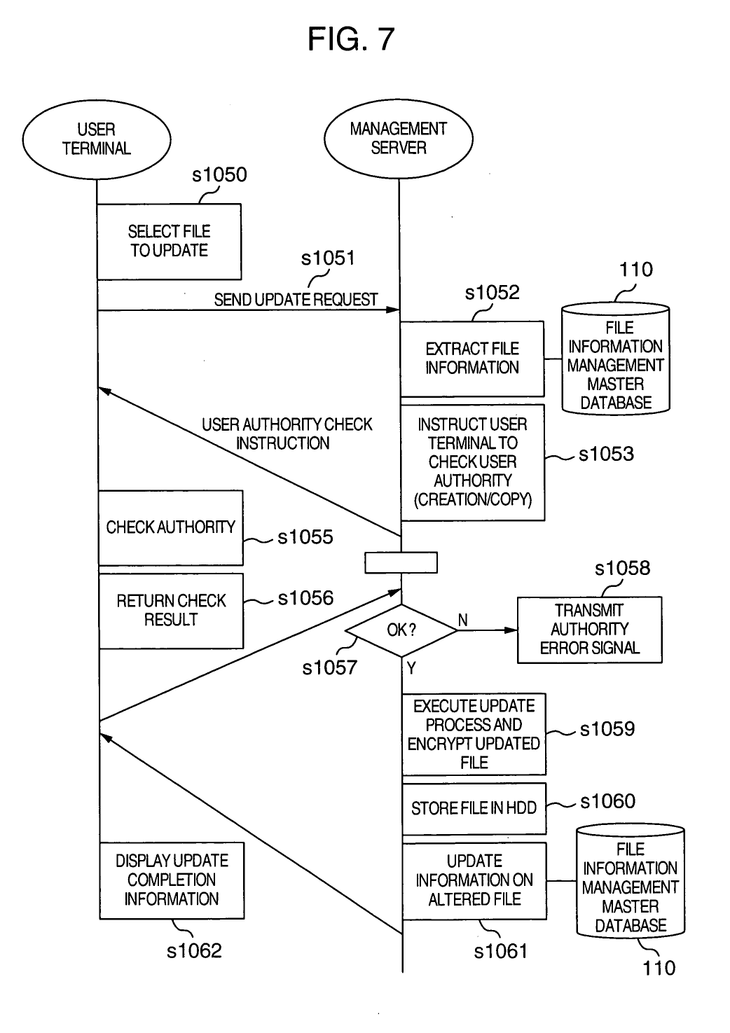

FIG. 7 is a flow chart showing a file update process in the classified information management method of this embodiment. There are cases where a management target file registered with the server 100 is updated. In these cases, a management target file to be updated (update may include overwriting and appending) is selected by the user terminal 138 (S1050) and an update request (containing information on the selection event) is transmitted to the server 100 (S1051).

The server 100 receives the update request and extracts information on a management target file corresponding to the update request from the file information management master database 110 (S1052). The extracted information includes information on access authority which has been associated with the management target file. Meanwhile, the server 100 instructs the user terminal 138 to check the user authority (S1053). The user terminal 138 executes the user authority check (S1055) and returns the result to the server 100 (S1056). Incidentally, it is also possible to let the user terminal 138 receive the user authority of the user corresponding to the update request and let the server 100 check the user authority with the access authority and thereby judge whether the management target file corresponding to the update request may be accessed or not.

The server 100 receives the check result and if the user authority does not match the access authority (S1057: N), sends an authority error signal to the user terminal 138 (S1058). If the user authority matches the access authority (S1057: Y), the server 100 executes an update process according to the update request, encrypts the updated management target file (S1059), and stores the encrypted management target file in the HDD 115 (S1060).

Subsequently, the server 100 extracts the management master information on the updated management target file and executes an update process regarding the file in the file information management master database 110 (S1061). Update completion information (indicating the update of the management target file has been completed) is sent to the user terminal 138, and the user terminal 138 receives and displays the update completion information (S1062).

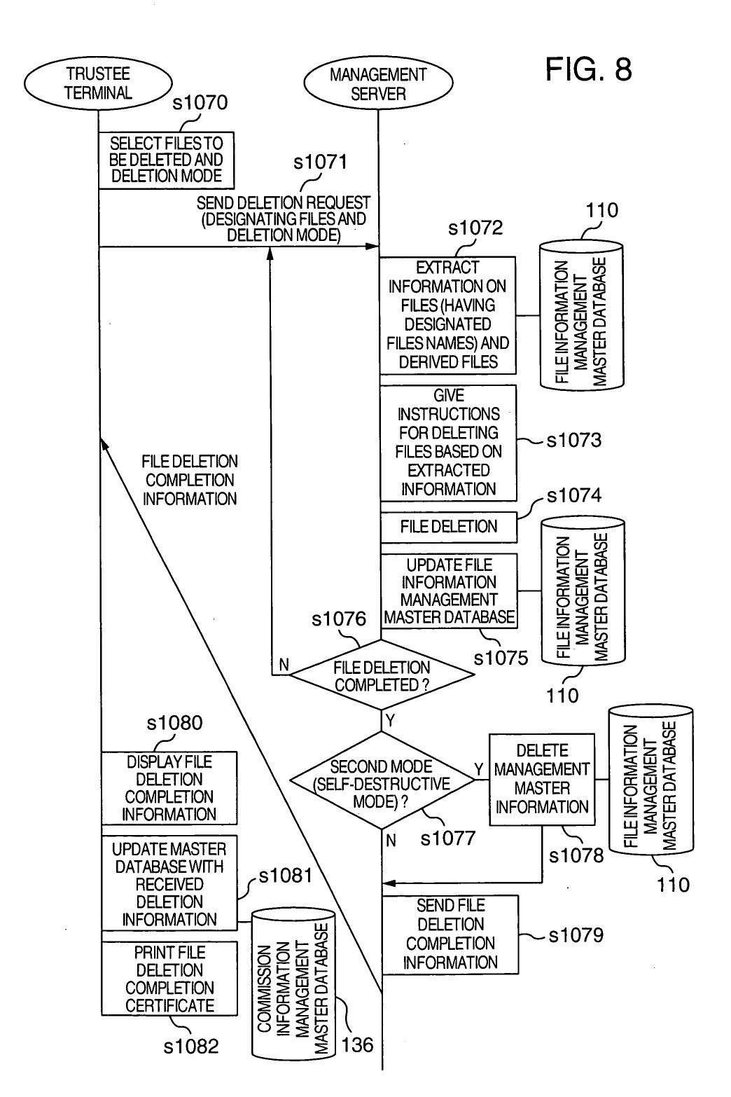

FIG. 8 is a flow chart showing a file deletion process in the classified information management method of this embodiment. The classified information management method of the present invention realizes a process perfectly deleting a management target file (containing classified information) from the HDD 115 (storage device). In this embodiment, the classified information management according to the present invention is applied to management target files that are entrusted by the truster to the trustee or the trustee terminal 135. Therefore, when the contract between the truster and the trustee ends or the commissioned business operation is completed, management target files relevant to the commissioned business operation have to be deleted.

When the need for deleting relevant management target files arises, management target files to be deleted are determined (1) based on an “outsourcing contract” which is made between the truster and the trustee or (2) based on a “deletion contract” which is made between the truster and the trustee when the deletion becomes necessary.

Each of the contracts (outsourcing and deletion) will hereinafter be called a “contract”. In each “contract”, pieces of information for determining the management target files to be deleted are enumerated. The information for determining the management target files to be deleted includes at least one of: file name; file creation date/time; file usage period; and file creator. In cases where the “contract” is written on paper, the user reads the “information for determining” specified in the contract and inputs information designating the management target files to be deleted through the trustee terminal 135 (or the system manager terminal 137), as in the following step S1070.

Meanwhile, in cases where the “contract” is written electronically (as electronic data), the trustee terminal 135, a terminal of the truster, or the management server 100 reads the “information for determining” from the electronic “contract” and then starts the process for deleting the management target files to be deleted.

In the case where the “contract” is written on paper, it is also possible to prepare the “information for determining” electronically and carry out a process similar to the case of the “electronic contract”. The “information for determining” is prestored in the commission information management master database 136.

In the case where the “contract” is written electronically, the “electronic contract” may also be stored in the commission information management master database 136.

When the need for deleting the management target files arises, a deletion instruction may be sent from the trustee side to the management server 100. It is also possible to previously register information on the timing for the deletion with the commission information management master database 136. The deletion start timing may be manually inputted based on the contract sheet (contract written on paper), or may previously be included in the “electronic contract”.

In these cases, a selection of management target files to be deleted and a selection of a “deletion mode” are made at the trustee terminal 135 (S1070) and a deletion request (containing information on the selection event) is transmitted to the server 100 (S1071). The “deletion mode” may include a first mode for deleting the management target files only and a second mode for deleting not only the management target files but also information (management master information) corresponding to the management target files stored in the file information management master database 110.

The server 100 receives the deletion request and extracts information on the management target files corresponding to the deletion request from the file information management master database 110 (S1072). In this case, in addition to the information on the management target files corresponding to the deletion request, the server 100 may also extract information on the copy files and/or the updated files (derived from the management target files) from the file information management master database 110.

The server 100 executes the deletion of the management target files (and the copy files and/or the updated files) from the HDD 115 (and the backup medium 116) based on the extracted information on the files (S1073, S1074).

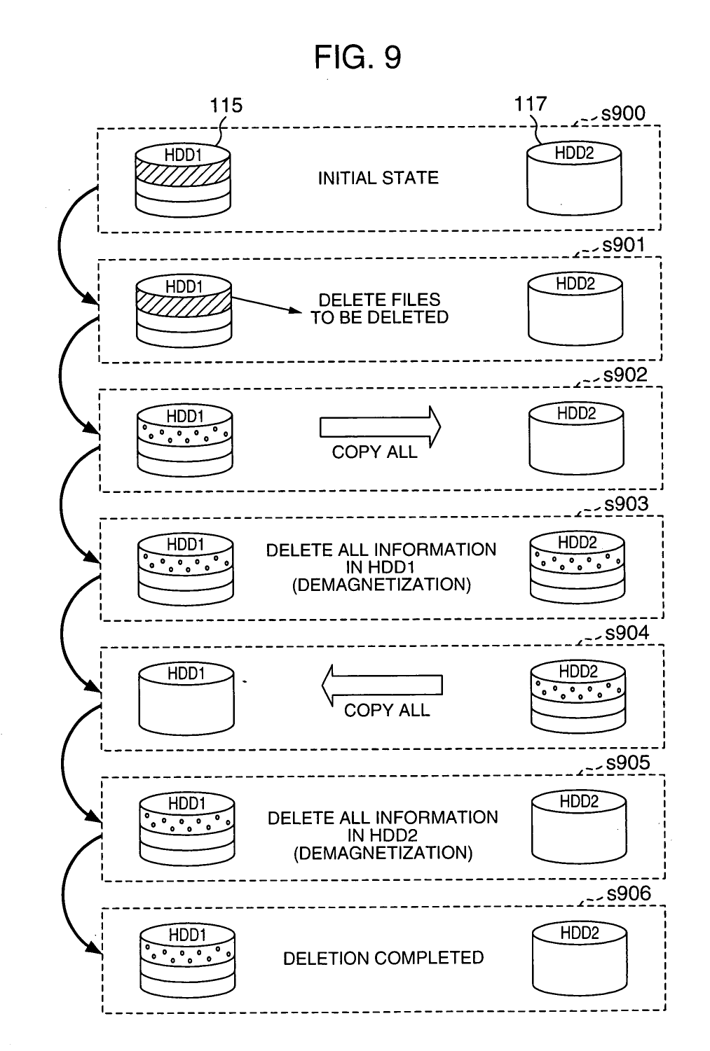

Here, the details of the process for deleting the files from the HDD 115 (or the backup medium 116) will be explained. FIG. 9 is a conceptual drawing showing a detailed file deletion process in the classified information management method of this embodiment. The “detailed file deletion process” means a process which is started after the deletion of the management target files (or copy/updated files) from the HDD 115 (or the backup medium 116) (S901) is executed after the initial state in which there remain files to be deleted (S900).

The server 100 copies information stored in the HDD 115 (i.e. all the remaining information other than the deleted files) to the second storage device 117 (S902). Meanwhile, the server 100 totally demagnetizes the HDD 115 by writing a prescribed data pattern to each memory unit (sector, etc.) of the HDD 115 for a preset number of times (S903).

Subsequently, the information stored in the second storage device 117 (i.e. the copy of the information which had been stored in the HDD 115 in the step S901 (after the deletion of the files)) is copied to the HDD 115 (S904). After the copy is completed, the server 100 totally demagnetizes the second storage device 117 by writing a prescribed data pattern to each memory unit (sector, etc.) of the second storage device 117 for a preset number of times (S905), by which the deletion process is completed (S906).

The server 100 updates the validity information on the management target files (and the copy/updated files) deleted as above, included in the management master information which has been registered with the file information management master database 110, into “invalid” (S1075). Subsequently, whether the above process has been completed for all the files corresponding to the deletion request or not is judged (S1076), and the above process (S1072-S1075) is repeated until all the corresponding files are deleted (S1076: Y). When the deletion is completed (S1076: Y), the information on the “deletion mode” is extracted and whether it is the second mode (for deleting not only the management target files but also information (management master information) corresponding to the management target files stored in the file information management master database 110) or not is judged (S1077). If the mode information included in the deletion request specifies the second mode for deleting the management master information in addition to the management target files (S1077: Y), the management master information on the management target files stored in the file information management master database 110 is located and deleted (S1078).

When the management target files, etc. corresponding to the deletion request have all been deleted, file deletion completion information (indicating the completion of the deletion) is sent to the trustee terminal 135 (S1079). The trustee terminal 135 receives the file deletion completion information and displays the information on a proper output interface, etc. (S1080). Based on the received file deletion completion information, the management master information stored in the commission information management master database 136 is updated for the deleted files (S1081). The completion of the deletion process is reported by printing a file deletion completion certificate on a print medium for example, by which the process is ended (S1082).

While the classified information management method was applied to the management target files in the above embodiment, the classified information management method can also be executed, for example, on the level of a business application that uses the management target files. In this case, when the business application is executed, whether the user has the authority or not in the business process authority database 111 shown in FIG. 1 (in which the presence/absence of the deletion authority, the backup authority and/or the usage authority of each user regarding each management target file is stipulated) is judged. If the user is judged to have the deletion authority, the backup authority and/or the usage authority, the management target file to be processed by the business application is extracted from the HDD 115 and provided to the business application.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

1. An information processing apparatus supporting secret information management, comprising:
a management master extraction module which receives a management target file containing secret information via an input interface and extracts management master information, including a file ID and information on validity of the management target file, from the management target file;
a storage device which stores a file management database with which the management master information on each management target file is registered;
a storage event output module which outputs a signal indicating a storage event of the management target file in the storage device to an output interface;
a deletion target extraction module which receives a deletion request regarding the management target file via the input interface and extracts information on the management target file corresponding to the deletion request from the file management database;
a file deletion module which executes the deletion of the management target file from the storage device based on the information on the management target file extracted by the deletion target extraction module;
a management master information update module which updates the validity information on the management target file deleted by the file deletion module, included in the management master information registered with the file management database, into invalid; and
a deletion information output module which outputs a signal indicating that the management target file has been deleted by the file deletion module to the output interface.

2. The information processing apparatus according to claim 1, further comprising a management master information deletion module which locates the management master information on the management target file which has been registered with the file management database and deletes the management master information in cases where deletion mode information included in the deletion request designates a mode requesting not only the deletion of the management target file but also the deletion of the management master information.

3. The information processing apparatus according to claim 1, further comprising:
an access authority extraction module which receives a backup request regarding a management target file via the input interface and extracts access authority information on the management target file corresponding to the backup request from the file management database;
an access authority judgment module which receives user authority information on a user corresponding to the backup request via the input interface and judges whether the management target file corresponding to the backup request may be accessed or not by checking the user authority information with the access authority information;
a copy generation module which extracts the management target file corresponding to the backup request from the storage device and generates a copy file of the management target file if the access authority judgment module judged that the management target file may be accessed;
a copy output module which outputs the copy file of the management target file to a backup medium; and
a copy file registration module which extracts management master information on the copy file and stores the extracted management master information in the file management database.

4. The information processing apparatus according to claim 1, further comprising:
an access authority extraction module which receives a usage request regarding a management target file via the input interface and extracts access authority information on the management target file corresponding to the usage request from the file management database;
an access authority judgment module which receives user authority information on a user corresponding to the usage request via the input interface and judges whether the management target file corresponding to the usage request may be accessed or not by checking the user authority information with the access authority information;
an available file output module which extracts the management target file corresponding to the usage request from the storage device and outputs the extracted management target file to the output interface if the access authority judgment module judged that the management target file may be accessed;
an updated file generation module which receives an update process for updating the management target file outputted by the available file output module via the input interface and thereby generates an updated file;
an updated file storage module which stores the updated file in the storage device; and
an updated file registration module which extracts management master information on the updated file and stores the extracted management master information in the file management database.

5. The information processing apparatus according to claim 3, further comprising:
a relevant deletion target extraction module which extracts information on the copy file derived from the management target file corresponding to the deletion request in addition to the information on the management target file from the file management database;
a relevant file deletion module which executes the deletion of the copy file from the backup medium based on the information on the copy file extracted by the relevant deletion target extraction module;
a relevant management master information update module which updates the validity information on the copy file deleted by the relevant file deletion module, included in the management master information registered with the file management database, into invalid; and
an informing module which informs a second information processing apparatus connected with the information processing apparatus via a network that the copy file has been deleted by the relevant file deletion module, via the output interface.

6. The information processing apparatus according to claim 4, further comprising:
a relevant deletion target extraction module which extracts information on the updated file derived from the management target file corresponding to the deletion request in addition to the information on the management target file from the file management database;
a relevant file deletion module which executes the deletion of the updated file from the storage device based on the information on the updated file extracted by the relevant deletion target extraction module;
a relevant management master information update module which updates the validity information on the updated file deleted by the relevant file deletion module, included in the management master information registered with the file management database, into invalid; and
an informing module which informs a second information processing apparatus connected with the information processing apparatus via a network that the updated file has been deleted by the relevant file deletion module, via the output interface.

7. The information processing apparatus according to claim 1, further comprising:
a business application process judgment module which judges whether a user has authority or not in a business process authority database, in which the presence/absence of deletion authority, backup authority or usage authority of each user regarding each management target file is stipulated, when a business application using a management target file is executed; and
a business application process execution module which extracts the management target file to be processed by the business application from the storage device and provides the management target file to the business application if the business application process judgment module judged that the user has the deletion authority, the backup authority or the usage authority regarding the management target file.

8. The information processing apparatus according to claim 1, further comprising:
a first copy execution module which copies information stored in the storage device into a second storage device after the deletion of the management target file from the storage device is executed by the file deletion module;
a first demagnetization execution module which writes a prescribed data pattern to each memory unit such as each sector of the storage device for a preset number of times;
a second copy execution module which copies the information stored in the second storage device back into the storage device; and
a second demagnetization execution module which writes a prescribed data pattern to each memory unit such as each sector of the second storage device for a preset number of times.

9. The information processing apparatus according to claim 5, further comprising:
a first copy execution module which copies information stored in the storage device and the backup medium to a second storage device after the deletion of the management target file and the copy file from the storage device and the backup medium is executed by the file deletion module and the relevant file deletion module;
a first demagnetization execution module which writes a prescribed data pattern to each memory unit such as each sector of the storage device and the backup medium for a preset number of times;
a second copy execution module which copies the information stored in the second storage device back into the storage device and the backup medium; and
a second demagnetization execution module which writes a prescribed data pattern to each memory unit such as each sector of the second storage device for a preset number of times.

10. The information processing apparatus according to claim 6, further comprising:
a first copy execution module which copies information stored in the storage device to a second storage device after the deletion of the management target file and the updated file from the storage device is executed by the file deletion module and the relevant file deletion module;
a first demagnetization execution module which writes a prescribed data pattern to each memory unit such as each sector of the storage device for a preset number of times;
a second copy execution module which copies the information stored in the second storage device back into the storage device; and
a second demagnetization execution module which writes a prescribed data pattern to each memory unit such as each sector of the second storage device for a preset number of times.

11. An information management method for managing secret information by use of an information processing apparatus, comprising the steps of:
receiving a management target file containing secret information through an input interface and extracting management master information, including a file ID, information on access authority to the management target file, and information on validity of the management target file, from the management target file;
registering the management master information on each management target file with a file management database;
storing the management target file in a storage device associating the same with the management master information;
outputting a signal indicating the storage event of the management target file in the storage device to an output interface;
receiving a deletion request regarding the management target file via the input interface and extracting information on the management target file corresponding to the deletion request from the file management database;
executing the deletion of the management target file from the storage device based on the information on the management target file extracted from the file management database;
updating the validity information on the management target file deleted from the storage device, included in the management master information registered in the file management database, into invalid; and
outputting a signal indicating that the management target file has been deleted to the output interface.
